(19) United States
(12) Patent Application Publication
(10) Pub. No.: US 2025/0269473 A1
(43) Pub. Date: Aug. 28, 2025

(54) CONDUCTIVE PASTE FOR BONDING

(71) Applicant: DAICEL CORPORATION, Osaka-shi, Osaka (JP)

(72) Inventors: Rumi NAGAI, Tokyo (JP); Takanori KOBATAKE, Tokyo (JP); Yoshihiko FUJIWARA, Tokyo (JP)

(73) Assignee: DAICEL CORPORATION, Osaka-shi, Osaka (JP)

(21) Appl. No.: 18/702,987

(22) PCT Filed: Nov. 22, 2022
(86) PCT No.: PCT/JP2022/043839

§ 371 Date: Apr. 19, 2024

(30) Foreign Application Priority Data
Nov. 30, 2021 (JP) 2021-194501

(51) Int. Cl. B23K 35/02; B22F 1/00; B22F 1/052; B22F 1/054; B22F 1/068; B22F 1/102; B22F 1/107; B22F 9/30; B23K 35/30; B23K 35/36; B23K 35/365

(52) U.S. Cl. CPC B23K 35/02; B22F 1/052; B22F 1/054; B22F 1/068; B22F 1/09; B22F 1/102; B22F 1/107; B22F 9/30; B23K 35/3006; B23K 35/3615; B23K 35/365; B22F 2301/255; B22F 2304/054; B22F 2998/10; B22F 2999/00

(57) ABSTRACT

Provided is a conductive paste for bonding which is excellent in stability during continuous discharge and storage stability and can suppress generation of voids during formation of a sintered body. The conductive paste for bonding contains: metal nanoparticles (A) having an average particle size of 1 nm or more and less than 100 nm; and a dispersion medium containing an organic solvent (a), an organic solvent (b), and an organic solvent (c); wherein the metal nanoparticles (A) are coated on surfaces thereof with an organic protective agent containing an amine and dispersed in the dispersion medium, and the organic solvents (a) to (c) are different compounds and satisfy the following formulas (1) to (6): 150° C.≤Ta≤250° C. (1); 150° C.≤Tb≤250° C. (2); 250° C.≤Tc≤350° C. (3); δa≥10.0 (4); δc≤9.0 (5); δc≤δb≤δa (6), where Ta to Tc represent boiling points of the organic solvents (a) to (c), respectively, and δa to δc represent Hansen solubility parameters of the organic solvents (a) to (c), respectively.

### TECHNICAL FIELD

The present disclosure relates to a conductive paste for bonding for forming sintered bodies such as a conductive wiring and a bonded structure to connect electronic elements. The present disclosure more specifically relates to a conductive paste for bonding for use in an application for forming a conductive wiring and a bonded structure to connect electronic elements such as a power semiconductor element and an LED element. The present application claims priority to JP 2021-194501, filed in Japan on Nov. 30, 2021, the contents of which are incorporated herein by reference.

### BACKGROUND ART

In installing an electronic element such as a power semiconductor element or an LED element, bonding a plurality of materials with high strength is required. For this purpose, a conductive wiring, a bonded structure, or a wiring board including the conductive wiring and the bonded structure is used.

For example, a method for forming the conductive wiring is known, in which a conductive paste containing conductive particles and an organic solvent is applied onto an insulating substrate by a printing method, and then sintered, thereby manufacturing a conductive wiring.

For example, Patent Document 1 discloses a conductive paste for bonding containing conductive particles and a specific ether-based solvent. It is described that, by using the conductive paste for bonding, printing can be performed without unevenness, and that a highly accurate conductive wiring or bonded structure capable of connecting a substrate and an electronic element with high bonding strength can be formed.

Patent Document 2 discloses a bonding material formed of a silver paste containing fine silver particles, a solvent, and an additive, in which the solvent includes a first solvent formed of a diol and a second solvent formed of a polar solvent having a lower surface tension than that of the first solvent, and the additive is a triol. It is described that, even when a thick coating film is formed, the bonding material can prevent bubble inclusion at the time of forming the coating film and generation of voids in a silver bonding layer.

Patent Document 3 discloses a paste-like metal particle composition containing specific metal particles and two types of volatile dispersion media having different dielectric constants, wherein the two types of volatile dispersion media are mixed at a mixing ratio at which they are not completely miscible at an ordinary temperature. It is described that the composition can suppress precipitation of the metal particles.

### CITATION LIST

### Patent Document

Patent Document 1: JP 2020-194786 A
Patent Document 2: JP 2017-201057 A
Patent Document 3: WO 2008/062548

### SUMMARY OF INVENTION

### Technical Problem

However, in the case of a conductive paste using an ether-based solvent, the solvent tends to float up in a syringe when the paste is applied by a dispensing device. Therefore, there is a problem that, when such a conductive paste is continuously discharged by a dispensing device, the weight of the paste discharged is hardly stabilized.

In addition, a conductive paste using two or more types of solvents tends to be inferior in storage stability, and also tends to be inferior in discharge stability after storage because the metal particles and the solvent are easily separated after storage (particularly after low-temperature storage).

For improving the discharge stability of the conductive paste, it is conceivable to use a highly polar solvent instead of a low polar solvent such as ether. However, a conductive paste using a highly polar solvent tends to generate voids when a sintered body is formed and tends to be inferior in bonding strength.

Therefore, an object of the present disclosure is to provide a conductive paste for bonding which is excellent in stability during continuous discharge and storage stability and can suppress generation of voids during formation of a sintered body.

### Solution to Problem

As a result of intensive studies to solve the above problems, the inventors of the present disclosure have found that a conductive paste for bonding containing specific metal nanoparticles and a dispersant containing specific three types of organic solvents is excellent in stability during continuous discharge and storage stability, and can suppress generation of voids during formation of a sintered body. The present disclosure relates to inventions completed based on these findings.

That is, the present disclosure provides a conductive paste for bonding containing: metal nanoparticles (A) having an average particle size of 1 nm or more and less than 100 nm; and a dispersion medium containing an organic solvent (a), an organic solvent (b), and an organic solvent (c);
wherein
the metal nanoparticles (A) are coated on surfaces thereof with an organic protective agent containing an amine and dispersed in the dispersion medium, and
the organic solvent (a), the organic solvent (b), and the organic solvent (c) are different compounds and satisfy the following formulas (1) to (6):

$$150 ° C . \leq Ta \leq 250 ° C . \qquad ( 1 )$$

$$150 ° C . \leq Tb \leq 250 ° C . \qquad ( 2 )$$

$$250 ° C . \leq Tc \leq 350 ° C . \qquad ( 3 )$$

$$δ a \geq 10 \qquad ( 4 )$$

$$δ c \leq 9 \qquad ( 5 )$$

$$δ c \leq δ b \leq δ a \qquad ( 6 )$$

where Ta to Tc represent boiling points of the organic solvents (a) to (c), respectively, and δa to δc represent Hansen solubility parameters of the organic solvents (a) to (c), respectively.

Preferably, the conductive paste for bonding further contains spherical metal particles (B) having an average particle size of from 0.5 to 1 μm and flat metal flakes (C) having an average particle size of from 1 to 10 μm.

Preferably, a total content proportion of the metal nanoparticles (A), the spherical metal particles (B), and the flat metal flakes (C) in the conductive paste for bonding is from 80 to 99.5 mass %.

Preferably, a content proportion of the metal nanoparticles (A) in all metal particles contained in the conductive paste for bonding is 50 mass % or less.

Preferably, the organic protective agent contains, as the amine, an aliphatic hydrocarbon monoamine (1) including an aliphatic hydrocarbon group and one amino group, the aliphatic hydrocarbon group having 6 or more carbon atoms in total, and the organic protective agent further contains at least one of an aliphatic hydrocarbon monoamine (2) or an aliphatic hydrocarbon diamine (3), the aliphatic hydrocarbon monoamine (2) including an aliphatic hydrocarbon group and one amino group, the aliphatic hydrocarbon group having 5 or less carbon atoms in total, and the aliphatic hydrocarbon diamine (3) including an aliphatic hydrocarbon group and two amino groups, the aliphatic hydrocarbon group having 8 or less carbon atoms in total. Preferably, the conductive paste for bonding further contains an organic solvent besides the organic solvent (a), the organic solvent (b), and the organic solvent (c).

Preferably, the organic solvent (a), the organic solvent (b), and the organic solvent (c) are uniformly dissolved at an ordinary temperature without phase separation.

### Advantageous Effects of Invention

The conductive paste for bonding of the present disclosure is excellent in stability during continuous discharge and storage stability and can suppress generation of voids during formation of a sintered body. Therefore, the conductive paste for bonding can be stably and continuously discharged by a dispensing device. In addition, since voids are less likely to be generated, it is possible to produce a sintered body such as a conductive wiring or a bonded structure having high bonding strength, and a wiring board including the conductive wiring and the bonded structure.

### BRIEF DESCRIPTION OF DRAWINGS

FIG. 1 shows an SAT image of a sintered body surface after die shear strength measurement of a sample produced in Example 1.

FIG. 2 shows an SAT image of a sintered body surface after die shear strength measurement of a sample produced in Comparative Example 5.

FIG. 3 shows an SAT image of a sintered body surface after die shear strength measurement of a sample produced in Comparative Example 7.

FIG. 4 shows an SEM image of the sintered body in a cross section of the sample produced in Example 1.

FIG. 5 shows an SEM image of the sintered body in a cross section of the sample produced in Comparative Example 5.

FIG. 6 shows an SEM image of the sintered body in a cross section of the sample produced in Comparative Example 7.

### Description of Embodiments

### Conductive Paste for Bonding

The conductive paste for bonding according to an embodiment of the present disclosure is a paste-like composition capable of forming a conductor that bonds members to each other. The conductive paste for bonding is, for example, a conductive paste for bonding for forming a sintered body (e.g., a conductive wiring or a bonded structure) for connecting electronic elements.

The conductive paste for bonding contains at least metal nanoparticles (A) having an average particle size of 1 nm or more and less than 100 nm, and a dispersion medium containing an organic solvent (a), an organic solvent (b), and an organic solvent (c). In the conductive paste for bonding, the metal nanoparticles (A) are dispersed in the dispersion medium.

### Dispersion Medium

The dispersion medium contains at least an organic solvent (a), an organic solvent (b), and an organic solvent (c). The organic solvent (a), the organic solvent (b), and the organic solvent (c) are different compounds and satisfy the following Formulas (1) to (6). Only one type of each of the organic solvent (a), the organic solvent (b), and the organic solvent (c) may be used, or two or more types thereof may be used.

$$150 ° C . \leq Ta \leq 250 ° C . \qquad ( 1 )$$

$$150 ° C . \leq Tb \leq 250 ° C . \qquad ( 2 )$$

$$250 ° C . \leq Tc \leq 350 ° C . \qquad ( 3 )$$

$$δ a \geq 10. \qquad ( 4 )$$

$$δ c \leq 9. \qquad ( 5 )$$

$$δ c \leq δ b \leq δ a \qquad ( 6 )$$

In the above Formulas, Ta to Tc represent boiling points of the organic solvents (a) to (c), respectively, and δa to δc represent Hansen solubility parameters of the organic solvents (a) to (c), respectively. In the present specification, the Hansen solubility parameter is sometimes referred to as “SP value” and represented by “δ”.

The organic solvents (a) to (c) are uniformly dissolved to be in a liquid form when mixed at a blending ratio used for the conductive paste for bonding, and each may be in a liquid form or a solid form at room temperature when it is present alone.

The organic solvent (a) satisfies at least Formula (1). That is, the boiling point Ta of the organic solvent (a) satisfies 150° C.≤Ta≤250° C., preferably 150° C.<Ta<250° C., more preferably 155° C.≤Ta≤220° C., and even more preferably 160° C.≤Ta≤200° C. By using the organic solvent (a) having a boiling point within the above range, the dispersion medium is easily volatilized during sintering, and a sintered body can be easily formed.

The organic solvent (a) satisfies at least Formula (4) [δa≥10.0]. The SP value δa of the organic solvent (a) is 10.0 or more, preferably 10.3 or more, and more preferably 10.4 or more within the range satisfying Formula (6). When the δa is 10.0 or more, dispersibility of the metal nanoparticles (A) is excellent, and separation of the metal particles from the dispersion medium can be suppressed. The δa of the organic solvent (a) is, for example, 16.0 or less, and may be 15.0 or less.

Examples of the organic solvent (a) include alcohol solvents, urea-based solvents, and aprotic polar solvents. Examples of the alcohol solvent include compounds having one or more hydroxy groups, and, among them, tertiary alcohols and ether alcohols are preferred. The alcohol solvent may have two or more hydroxy groups. The ether alcohol is a compound having an ether bond and a hydroxy group, and examples thereof include a (poly)alkylene glycol monoalkyl ether and an alkoxy group-substituted alcohol.

Specific examples of the organic solvent (a) include pinacol (δ:10.7, boiling point: 172° C.), tetramethylurea (δ:10.6, boiling point: 177° C.), 3-methoxybutanol (δ: 10.6, boiling point: 161° C.), 1-methylcyclohexanol (δ:10.4, boiling point: 155° C.), and methyl carbitol (diethylene glycol monomethyl ether) (δ:10.7, boiling point: 193° C.).

The organic solvent (b) satisfies at least Formula (2). That is, the boiling point Tb of the organic solvent (b) satisfies 150° C.≤Tb≤250° C., preferably 150° C.<Tb<250° C., more preferably 180° C. ≤Tb≤248° C., and even more preferably 200° C.≤Tb≤245° C. By using the organic solvent (b) having a boiling point within the above range, the dispersion medium is easily volatilized during sintering, and a sintered body can be easily formed. In addition, by using the organic solvent (b) having a boiling point of 250° C. or less, generation of voids during sintering can be suppressed.

The organic solvent (b) satisfies at least Formula (6). The SP value δb of the organic solvent (b) is preferably from 8.0 to 12.0, more preferably from 8.5 to 11.0, and even more preferably from 9.0 to 10.5 within the range satisfying Formula (6). When the δb is within the above range, there is a tendency that miscibility between the organic solvent (a) and the organic solvent (c) is improved, that separation hardly occurs, and that continuous discharge stability and storage stability are more excellent.

Examples of the organic solvent (b) include alcohol solvents, ester solvents, ketone solvents, and amine-based solvents. Examples of the alcohol solvent include solvent compounds having one or more hydroxy groups, and, among them, tertiary alcohols, ether alcohols, and ester alcohols are preferred. The ether alcohol is a compound having an ether bond and a hydroxy group, and examples thereof include a (poly)alkylene glycol monoalkyl ether and an alkoxy group-substituted alcohol. The ester alcohol is a compound having an ester bond and a hydroxy group, and examples thereof include (poly)alkylene glycol monoalkyl ether monoesters. Examples of the ester solvent include diacetates of diols such as (poly)alkylene glycols. The ketone solvent is preferably a cyclic ketone. The amine-based solvent is preferably an alkylamine.

The organic solvent (b) is selected on the premise that it satisfies Formula (6) in a relationship with the organic solvents (a) and (c). Specifically, the organic solvent (b) that can be used includes, for example, d-Camphor (camphor) (δ:10.4, boiling point: 204° C.), 1-heptanol (δ:10.0, boiling point: 177° C.), butyl carbitol (diethylene glycol monobutyl ether) (δ:10.2, boiling point: 231° C.), ethyl carbitol (diethylene glycol monoethyl ether) (δ:10.5, boiling point: 196° C.), tripropylene glycol monomethyl ether (δ:9.4, boiling point: 243° C.), α-terpineol (δ:9.3, boiling point: 220° C.), dihydroterpineol (δ:9.0, boiling point: 210° C.), 1,3-butanediol diacetate (δ: 9.2, boiling point: 232° C.), propylene glycol diacetate (δ: 9.3, boiling point: 190° C.), butyl carbitol acetate (δ:9.0, boiling point: 247° C.), dipropylene glycol butyl ether (δ: 9.2, boiling point: 230° C.), isophorone (δ:9.5, boiling point: 213° C.), 1-decanol (δ: 9.6, boiling point: 230° C.), propylene glycol monobutyl ether (δ:9.0, boiling point: 170° C.), and 1-nonanol (δ:9.8, boiling point: 214° C.).

Preferably, the boiling point Tb of the organic solvent (b) is higher than the boiling point Ta of the organic solvent (a), i.e., Tb>Ta. A temperature difference [Tb−Ta] between Tb and Ta is preferably 2° C. or more, more preferably 5° C. or more, and even more preferably 10° C. or more. When the temperature difference is 2° C. or more, generation of voids during sintering can be further suppressed.

The organic solvent (c) satisfies at least Formula (3). That is, the boiling point Tc of the organic solvent (c) satisfies 250° C.≤Tc≤350° C., preferably 250° C.<Tc<350° C., more preferably 250° C.<Tc≤320° C., and even more preferably 250° C.<Tc≤300° C. By using the organic solvent (c) having a boiling point within the above range, rapid volatilization of the organic solvent (a) and the organic solvent (b) and generation of voids, during sintering, can be suppressed.

The organic solvent (c) satisfies at least Formula (5) [δc≤9.0]. The SP value δc of the organic solvent (c) is 9.0 or less, preferably 8.7 or less, and more preferably 8.5 or less. When the 8 is 9.0 or less, generation of voids during sintering can be suppressed. The δc of the organic solvent (c) is, for example, 6.0 or more, and may be 7.0 or more.

Examples of the organic solvent (c) include ether solvents, alkane solvents, and ester solvents. Examples of the ether solvent include (poly)alkylene glycol dialkyl ether. The alkane solvent is preferably an alkane having 14 or more carbon atoms (for example, from 14 to 20 carbon atoms). Examples of the ester solvent include esters of (poly)alkylene glycol alkyl ethers and fatty acids.

Specific examples of the organic solvent (c) include dibutyl carbitol (diethylene glycol dibutyl ether) (δ:8.3, boiling point: 255° C.), tetradecane (δ:7.9,boiling point: 254° C.), and hexadecane (δ:8.0, boiling point: 287° C.).

Preferably, the boiling point Tc of the organic solvent (c) is higher than the boiling point Tb of the organic solvent (b), i.e., Tc>Tb. A temperature difference [Tc−Tb] between Tc and Tb is preferably 2° C. or more, more preferably 6° C. or more, and even more preferably 10° C. or more. When the temperature difference is 2° C. or more, generation of voids during sintering can be further suppressed.

Preferably, the boiling point Tc of the organic solvent (c) is higher than the boiling point Ta of the organic solvent (a), i.e., Tc>Ta. A temperature difference [Tc−Ta] between Tc and Ta is preferably 30° C. or more, more preferably 50° C. or more, and even more preferably 60° C. or more. When the temperature difference is 30° C. or more, generation of voids during sintering can be further suppressed.

The SP value δa of the organic solvent (a), the SP value δb of the organic solvent (b), and the SP value δc of the organic solvent (c) satisfy the above Formula (6) [δc≤δb≤δa]. Above all, preferably, δb is higher than δc, that is, δc<δb is satisfied. Also, preferably, δa is higher than δb, that is, δb<δa is satisfied.

A difference [δb−δc] between δb and δc is preferably 0.1 or more, more preferably 0.2 or more, and even more preferably 0.5 or more. When the difference is 0.1 or more, the dispersibility of the metal particles is more excellent and the continuous discharge stability is more excellent. The difference is preferably 2.0 or less, more preferably 1.5 or less, and even more preferably 1.3 or less. When the difference is 2.0 or less, the metal particles and the dispersion medium are less likely to be separated, and the continuous discharge stability and the storage stability are more excellent.

A difference between δa and δb [δa−δb] is preferably 0.1 or more, more preferably 0.2 or more, and even more preferably 0.5 or more. When the difference is 0.1 or more, the dispersibility of the metal particles is more excellent and the continuous discharge stability is more excellent. The difference is preferably 2.5 or less, more preferably 2.0 or less, and even more preferably 1.8 or less. When the difference is 2.5 or less, the metal particles and the dispersion medium are less likely to be separated, and the continuous discharge stability and the storage stability are more excellent.

A difference [δa−δc] between δa and δc based on Formulas (4) and (5) is 1.0 or more, preferably 1.5 or more, and more preferably 2.0 or more. When the difference is 1.0 or more, generation of voids during sintering can be further suppressed. The difference is preferably 5.0 or less, more preferably 4.0 or less, and even more preferably 3.0 or less. When the difference is 5.0 or less, the metal particles and the dispersion medium are less likely to be separated, and the continuous discharge stability and the storage stability are more excellent.

A proportion [organic solvent (a)/{organic solvent (a)+organic solvent (b)+organic solvent (c)}] of the organic solvent (a) to a total amount of 100 mass % of the organic solvent (a), the organic solvent (b), and the organic solvent (c) is preferably from 5 to 70 mass %, more preferably from 10 to 60 mass %, and even more preferably from 15 to 50 mass %. When the proportion is within the above range, the dispersion medium is easily volatilized during sintering, a sintered body can be easily formed, and the dispersibility of the metal particles is more excellent.

A proportion [organic solvent (b)/{organic solvent (a)+organic solvent (b)+organic solvent (c)}] of the organic solvent (b) to a total amount of 100 mass % of the organic solvent (a), the organic solvent (b), and the organic solvent (c) is preferably from 5 to 70 mass %, more preferably from 10 to 60 mass %, and even more preferably from 15 to 50 mass %. When the proportion is within the above range, the miscibility among the organic solvents is excellent, and the continuous discharge stability and the storage stability are more excellent.

A proportion [organic solvent (c)/{organic solvent (a)+organic solvent (b)+organic solvent (c)}] of the organic solvent (c) to a total amount of 100 mass % of the organic solvent (a), the organic solvent (b), and the organic solvent (c) is preferably from 5 to 70 mass %, more preferably from 10 to 60 mass %, and even more preferably from 15 to 50 mass %. When the proportion is within the above range, generation of voids during sintering can be further suppressed.

A content of the organic solvent (c) relative to 100 parts by mass of the organic solvent (a) is preferably from 20 to 400 parts by mass, more preferably from to 300 parts by mass, and even more preferably from 50 to 200 parts by mass. 30 When the content is within the above range, balance between the amounts of the organic solvent (a) and the organic solvent (c) blended is good, and void suppression during sintering and the dispersibility of the metal particles are further improved.

A content of the organic solvent (b) relative to a total amount of 100 parts by mass of the organic solvent (a) and the organic solvent (c) is preferably from 10 to 200 parts by mass, more preferably from 20 to 150 parts by mass, and even more preferably from 40 to 100 parts by mass. When the content is within the above range, the miscibility between the organic solvent (a) and the organic solvent (c) is further improved, and the continuous discharge stability and the low-temperature storage property are more excellent.

The dispersion medium may contain an additional solvent (organic solvent) besides the organic solvent (a), the organic solvent (b), and the organic solvent (c). A total content proportion of the organic solvent (a), the organic solvent (b) and the organic solvent (c) in the dispersion medium is preferably 50 mass % or more, more preferably 70 mass % or more, even more preferably 80 mass % or more, still more preferably 90 mass % or more, and particularly preferably 95 mass % or more, relative to a total amount of 100 mass % of the dispersion medium. When the content proportion is 50 mass % or more, the dispersibility of the metal particles and the miscibility among the organic solvents are more excellent, and the continuous discharge stability, the storage stability, and void formation suppression during sintering are more excellent.

When the organic solvent (a), the organic solvent (b), and the organic solvent (c) are mixed at a blending ratio used for the conductive paste for bonding, it is preferable that the organic solvent (a), the organic solvent (b), and the organic solvent (c) are uniformly dissolved at an ordinary temperature without phase separation. In the conductive paste for bonding, it is preferable that the organic solvent (a), the organic solvent (b), and the organic solvent (c) are uniformly dissolved at an ordinary temperature without phase separation. In particular, the organic solvents preferably do not cause phase separation at from 22 to 28° C. (preferably from 10 to 30° C., and more preferably from 0 to 35° C.).

### Metal Nanoparticles (A)

The metal nanoparticles (A) have a configuration in which the surfaces of the metal nanoparticles are coated with an organic protective agent containing an amine, more specifically, a configuration in which unshared electron pairs of the amine are electrically coordinated to the metal nanoparticle surfaces. Since the metal nanoparticles (A) have the above configuration, re-aggregation of the metal nanoparticles (A) is prevented, and a highly dispersed state can be stably maintained in the conductive paste for bonding. Only one type of the metal nanoparticles (A) may be used, or two or more types thereof may be used.

The metal nanoparticles (A) have an average particle size of 1 nm or more and less than 100 nm, preferably from 2 to 80 nm, more preferably from 5 to 70 nm, and even more preferably from 10 to 60 nm. The average particle size is a size excluding the protective agent covering their surfaces (that is, the size of the metal nanoparticles themselves). The average particle size is determined as an average particle size (median diameter) converted into a volume distribution on the assumption that the particles have an aspect ratio of 1, based on the particle size determined by transmission electron microscope (TEM) observation. When two or more types of the metal nanoparticles (A) are contained, the average particle size refers to an average particle size of all the metal nanoparticles (A).

Examples of the metal constituting the metal nanoparticles (A) include conductive metals such as gold, silver, copper, nickel, aluminum, rhodium, cobalt, ruthenium, platinum, palladium, chromium, and indium. Silver particles (i.e., silver nanoparticles) are preferred as the metal nanoparticles in that the silver particles are fused to each other at a temperature of approximately 100° C., and can form a conductive connection member for an electronic component or the like even on a general-purpose plastic substrate with low heat resistance.

The metal nanoparticles (A) are surface-modified metal nanoparticles having a configuration in which surfaces of metal nanoparticles are coated with an organic protective agent containing an amine. Only one type of the amine may be used, or two or more types thereof may be used. The organic protective agent may contain a compound besides the amine.

The amine is a compound in which at least one hydrogen atom of ammonia is substituted with a hydrocarbon group, and includes a primary amine, a secondary amine, and a tertiary amine. In addition, the amine may be a monoamine or a polyamine such as a diamine.

The amine preferably contains at least one selected from a monoamine (1) having 6 or more carbon atoms in total and represented by Formula (a-1) below, where R¹, R², and R³ are identical or different and are hydrogen atoms or monovalent hydrocarbon groups (excluding the case in which R¹, R², and R³ are all hydrogen atoms); a monoamine (2) having 5 or less carbon atoms in total and represented by Formula (a-1) below, where R¹, R², and R³ are identical or different and are hydrogen atoms or monovalent hydrocarbon groups (excluding the case in which R¹, R², and R³ are all hydrogen atoms); and a diamine (3) having 8 or less carbon atoms in total and represented by Formula (a-2), where R⁸ is a divalent hydrocarbon group, and R⁴ to R⁷ are identical or different and are hydrogen atoms or monovalent hydrocarbon groups; and in particular, preferably contains the monoamine (1) in combination with the monoamine (2) and/or the diamine (3).

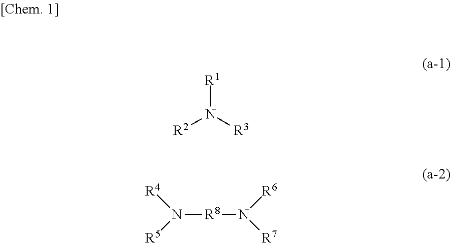

The hydrocarbon group includes aliphatic hydrocarbon groups, alicyclic hydrocarbon groups, and aromatic hydrocarbon groups. Among them, an aliphatic hydrocarbon group and an alicyclic hydrocarbon group are preferred, and an aliphatic hydrocarbon group is particularly preferred. Thus, the monoamine (1), the monoamine (2), and the diamine (3) are preferably an aliphatic monoamine (1), an aliphatic monoamine (2), and an aliphatic diamine (3).

Examples of the monovalent aliphatic hydrocarbon group include an alkyl group and an alkenyl group. Examples of the monovalent alicyclic hydrocarbon group include a cycloalkyl group and a cycloalkenyl. Examples of the divalent aliphatic hydrocarbon group include an alkylene group and an alkenylene group. Examples of the divalent alicyclic hydrocarbon group include a cycloalkylene group and a cycloalkenylene group.

Examples of the monovalent hydrocarbon group in R¹, R², and R³ include alkyl groups having approximately from 1 to 20 carbon atoms, such as a methyl group, an ethyl group, a propyl group, an isopropyl group, a butyl group, an isobutyl group, an s-butyl group, a t-butyl group, a pentyl group, a hexyl group, a decyl group, a dodecyl group, a tetradecyl group, and an octadecyl group; alkenyl groups having approximately from 2 to 20 carbon atoms, such as a vinyl group, an allyl group, a methallyl group, a 1-propenyl group, an isopropenyl group, a 1-butenyl group, a 2-butenyl group, a 3-butenyl group, a 1-pentenyl group, a 2-pentenyl group, a 3-pentenyl group, a 4-pentenyl group, and a 5-hexenyl group; cycloalkyl groups having approximately from 3 to 20 carbon atoms, such as a cyclopropyl group, a cyclobutyl group, a cyclopentyl group, a cyclohexyl group, and a cyclooctyl group; and cycloalkenyl groups having approximately from 3 to 20 carbon atoms, such as a cyclopentenyl group and a cyclohexenyl group.

Examples of the monovalent hydrocarbon group in R⁴ to R⁷ include those having 7 or less carbon atoms among those exemplified as the monovalent hydrocarbon group in R¹, R², and R³.

Examples of the divalent hydrocarbon group in R⁸ include alkylene groups having from 1 to 8 carbon atoms, such as a methylene group, a methylmethylene group, a dimethylmethylene group, an ethylene group, a propylene group, a trimethylene group, a tetramethylene group, a pentamethylene group, and a heptamethylene group; and alkenylene groups having from 2 to 8 carbon atoms, such as a vinylene group, a propenylene group, a 1-butenylene group, a 2-butenylene group, a butadienylene group, a pentenylene group, a hexenylene group, a heptenylene group, and an octenylene group.

The hydrocarbon groups in the above R¹ to R⁸ may have a substituent of any type [e.g., such as a halogen atom, an oxo group, a hydroxy group, a substituted oxy group (e.g., such as a C₁₋₄ alkoxy group, a C₆₋₁₀ aryloxy group, a C₇₋₁₆ aralkyloxy group, or a C₁₋₄ acyloxy group), a carboxy group, a substituted oxycarbonyl group (e.g., such as a C₁₋₄ alkoxycarbonyl group, a C₆₋₁₀ aryloxycarbonyl group, or a C₇₋₁₆ aralkyloxycarbonyl group), a cyano group, a nitro group, a sulfo group, or a heterocyclic group]. The hydroxy group and the carboxy group may be protected by a protective group commonly used in the field of organic synthesis.

The monoamine (1) is a compound having a function of imparting high dispersibility to the metal nanoparticles. Examples of the monoamine (1) include primary amines having a linear alkyl group, such as hexylamine, heptylamine, octylamine, nonylamine, decylamine, undecylamine, dodecylamine, tridecylamine, tetradecylamine, pentadecylamine, hexadecylamine, heptadecylamine, and octadecylamine; primary amines having a branched alkyl group, such as isohexylamine, 2-ethylhexylamine, and tert-octylamine; primary amines having a cycloalkyl group, such as cyclohexylamine; primary amines having an alkenyl group, such as oleylamine; secondary amines having a linear alkyl group, such as N,N-dipropylamine, N,N-dibutylamine, N,N-dipentylamine, N,N-dihexylamine, N,N-dipeptylamine, N,N-dioctylamine, N,N-dinonylamine, N,N-didecylamine, N,N-diundecylamine, N,N-didodecylamine, and N-propyl-N-butylamine; secondary amines having a branched alkyl group, such as N,N-diisohexylamine and N,N-di(2-ethylhexyl)amine; tertiary amines having a linear alkyl group, such as tributylamine and trihexylamine; and tertiary amines having a branched alkyl group, such as triisohexylamine and tri(2-ethylhexyl)amine.

Among the monoamines (1), an amine (particularly, a primary amine) having 6 or more carbon atoms in total and having a linear alkyl group is preferred from the viewpoint that, when an amino group is adsorbed on the surface of the metal nanoparticle, a gap between the metal nanoparticle and another metal nanoparticle can be further secured and thus the effect of preventing aggregation of the metal nanoparticles is improved. An upper limit of the total number of carbon atoms in the monoamine (1) is preferably approximately 18, more preferably 16, and particularly preferably 12, in view of availability and ease of removal during sintering. In particular, the monoamine (1) is preferably hexylamine, heptylamine, octylamine, nonylamine, decylamine, undecylamine, dodecylamine, or the like.

In addition, when an amine having a branched alkyl group (particularly, a primary amine) among the monoamines (1) is used, high dispersibility can be imparted to the metal nanoparticles with a smaller amount due to the steric factor of the branched alkyl group as compared with the case of using an amine having the same total number of carbon atoms and having a linear alkyl group. Therefore, the amine can be efficiently removed during sintering, particularly during low-temperature sintering, and a sintered body having more excellent electrical conductivity can be obtained. In this respect, the amine having a branched alkyl group is preferred.

As the amine having a branched alkyl group, amines having from 6 to 16 (preferably from 6 to 10) carbon atoms in total and having a branched alkyl group, such as isohexylamine and 2-ethylhexylamine, are particularly preferred, and, from the viewpoint of steric factors, amines having a branched alkyl group which is branched at the second carbon atom from the nitrogen atom, such as 2-ethylhexylamine, are particularly effective.

Among them, the monoamine (1) preferably includes an aliphatic hydrocarbon monoamine which includes an aliphatic hydrocarbon group and one amino group, the aliphatic hydrocarbon group having 6 or more carbon atoms in total.

The monoamine (2) has a shorter hydrocarbon chain than that of the monoamine (1), and thus the function of the monoamine (2) itself to impart high dispersibility to the silver nanoparticles is considered to be low. However, the monoamine (2) has a high coordination ability to a metal atom due to its higher polarity than that of the monoamine (1), and thus is considered to have an effect of promoting complex formation. In addition, the monoamine (2) has a short hydrocarbon chain and thus can be removed from the metal nanoparticle surfaces in a short time (e.g., not longer than 30 minutes and preferably not longer than 20 minutes) even in low-temperature sintering, thus providing a sintered body with excellent electrical conductivity.

Examples of the monoamine (2) include primary amines having from 2 to 5 carbon atoms in total and having a linear or branched alkyl group, such as ethylamine, n-propylamine, isopropylamine, n-butylamine, isobutylamine, sec-butylamine, tert-butylamine, pentylamine, isopentylamine, and tert-pentylamine; and secondary amines having from 2 to 5 carbon atoms in total and having a linear or branched alkyl group, such as N-methyl-N-propylamine, N-ethyl-N-propylamine, N,N-dimethylamine, and N,N-diethylamine.

The monoamine (2) is, among them, preferably a primary amine having from 2 to 5 carbon atoms in total (preferably from 4 to 5 carbon atoms in total) and having a linear or branched alkyl group, such as n-butylamine, isobutylamine, sec-butylamine, tert-butylamine, pentylamine, isopentylamine, and tert-pentylamine, and in particular, preferably a primary amine having from 2 to 5 carbon atoms in total (preferably from 4 to 5 carbon atoms in total) and having a linear alkyl group, such as n-butylamine.

Among them, the monoamine (2) is preferably an aliphatic hydrocarbon monoamine (2) including an aliphatic hydrocarbon group and one amino group, the aliphatic hydrocarbon group having 5 or less carbon atoms in total.

The diamine (3) has 8 or less (e.g., from 1 to 8) carbon atoms in total and has a high coordination ability to a metal atom due to its higher polarity than that of the monoamine (1), and thus is considered to have an effect of promoting complex formation. In addition, the diamine (3) has an effect of promoting thermal decomposition of the complex at a lower temperature and in a short time in the thermal decomposition of the complex, and the use of the diamine (3) allows more efficient manufacture of the metal nanoparticles. Furthermore, the surface-modified metal nanoparticles having a configuration in which the metal nanoparticles are coated with the protective agent containing the diamine (3) exhibit excellent dispersion stability in a dispersion medium containing a highly polar solvent. Moreover, the diamine (3) has a short hydrocarbon chain and thus can be removed from the metal nanoparticle surfaces in a short time (e.g., not longer than 30 minutes and preferably not longer than 20 minutes) even in low-temperature sintering, thus providing a sintered body with excellent electrical conductivity.

Examples of the diamine (3) may include diamines of Formula (a-2) in which R⁴ to R⁷ are hydrogen atoms, and R⁸ is a linear or branched alkylene group, such as ethylenediamine, 1,3-propanediamine, 2,2-dimethyl-1,3-propanediamine, 1,4-butanediamine, 1,5-pentanediamine, 1,6-hexanediamine, 1,7-heptanediamine, 1,8-octanediamine, and 1,5-diamino-2-methylpentane; diamines of Formula (a-2) in which R⁴ and R⁶ are identical or different and linear or branched alkyl groups, R⁵ and R⁷ are hydrogen atoms, and R⁸ is a linear or branched alkylene group, such as N,N′-dimethylethylenediamine, N,N′-diethylethylenediamine, N,N′-dimethyl-1,3-propanediamine, N,N′-diethyl-1,3-propanediamine, N,N′-dimethyl-1,4-butanediamine, N,N′-diethyl-1,4-butanediamine, and N,N′-dimethyl-1,6-hexanediamine; and diamines of Formula (a-2) in which R⁴ and R⁵ are identical or different and linear or branched alkyl groups, R⁶ and R⁷ are hydrogen atoms, and R⁸ is a linear or branched alkylene group, such as N,N-dimethylethylenediamine, N,N-diethylethylenediamine, N,N-dimethyl-1,3-propanediamine, N,N-diethyl-1,3-propanediamine, N,N-dimethyl-1,4-butanediamine, N,N-diethyl-1,4-butanediamine, and N,N-dimethyl-1,6-hexanediamine.

Among them, diamines of Formula (a-2) in which R⁴ and R⁵ are identical or different and linear or branched alkyl groups, R⁶ and R⁷ are hydrogen atoms, and R⁸ is a linear or branched alkylene group [in particular, diamines of Formula (a-2) in which R⁴ and R⁵ are linear alkyl groups, R⁶ and R⁷ are hydrogen atoms, and R⁸ is a linear alkylene group] are preferred.

In diamines of Formula (a-2) in which R⁴ and R⁵ are identical or different and are linear or branched alkyl groups, and R⁶ and R⁷ are hydrogen atoms, that is, diamines having a primary amino group and a tertiary amino group, the primary amino group has a high coordination ability to a metal atom, but the tertiary amino group has a poor coordination ability to a metal atom, and thus this prevents the resulting complex from being excessively complicated, thereby allowing the complex to be thermally decomposed at a lower temperature and in a shorter time in the thermal decomposition of the complex. Among them, diamines having 6 or less (e.g., from 1 to 6) carbon atoms in total are preferred, and diamines having 5 or less (e.g., from 1 to 5) carbon atoms in total are more preferred in that they can be removed from the metal nanoparticle surfaces in a short time in low-temperature sintering.

Among them, the diamine (3) is preferably an aliphatic hydrocarbon diamine (3) including an aliphatic hydrocarbon group and two amino groups, the aliphatic hydrocarbon group having 8 or less carbon atoms in total.

In the amine containing the monoamine (1) in combination with the monoamine (2) and/or the diamine (3), the proportions of these amines used are not particularly limited and is preferably in the range described below based on the total amount of the amines [monoamine (1)+monoamine (2)+diamine (3); 100 mol %].

Content of monoamine (1): for example, from 5 to 65 mol % (The lower limit is preferably 10 mol %, and more preferably 15 mol %. The upper limit is preferably 50 mol %, more preferably 40 mol %, and even more preferably 35 mol %.)

Total content of monoamine (2) and diamine (3): for example, from 35 to 95 mol % (The lower limit is preferably 50 mol %, more preferably 60 mol %, and even more preferably 65 mol %. The upper limit is preferably 90 mol %, and more preferably 85 mol %.)

Furthermore, when using the monoamine (2) and the diamine (3) together, each content of the monoamine (2) and the diamine (3) is preferably in the range described below based on the total amount of the amines [monoamine (1)+monoamine (2)+diamine (3); 100 mol %].

Monoamine (2): for example, from 5 to 70 mol % (The lower limit is preferably 10 mol %, and more preferably 15 mol %. The upper limit is preferably 65 mol %, and more preferably 60 mol %.)

Diamine (3): for example, from 5 to 50 mol % (The lower limit is preferably 10 mol %. The upper limit is preferably 45 mol %, and more preferably 40 mol %.)

When the content of the monoamine (1) is equal to or more than the lower limit value, the dispersion stability of the metal nanoparticles is excellent; and, when the content is equal to or less than the upper limit value, the amine tends to be easily removed by low-temperature sintering.

When the content of the monoamine (2) is within the above range, the effect of promoting complex formation is easily obtained. In addition, sintering can be performed at a low temperature for a short time, and, further, the diamine (3) is easily removed from the surfaces of the metal nanoparticles during sintering.

When the content of the diamine (3) is within the above range, the effect of promoting complex formation and the effect of promoting thermal decomposition of the complex are easily obtained. Also, the surface-modified metal nanoparticles having a configuration in which the metal nanoparticles are coated with the protective agent containing the diamine (3) exhibit excellent dispersion stability in a dispersion medium containing a highly polar solvent.

When the monoamine (2) and/or the diamine (3) having high coordination ability to metal atoms is used in the above conductive paste for bonding, the amount of the monoamine (1) used can be reduced according to the proportion of the monoamine (2) and/or the diamine (3) used, and, in the case of sintering at a low temperature for a short time, these amines are easily removed from the surfaces of the metal nanoparticles, and the sintering of the metal nanoparticles can sufficiently proceed.

The amine used as the organic protective agent may contain an additional amine besides the monoamine (1), the monoamine (2), and the diamine (3). A proportion of the total content of the monoamine (1), the monoamine (2), and the diamine (3) in all the amines contained in the organic protective agent is, for example, preferably 60 mass % or more (e.g., from 60 to 100 mass %), more preferably 80 mass % or more, and even more preferably 90 mass % or more. That is, the content of the additional amine is preferably 40 mass % or less, more preferably 20 mass % or less, and most preferably 10 mass % or less.

The amount of the amine [in particular, monoamine (1)+monoamine (2)+diamine (3)] used is not particularly limited, and is preferably approximately from 1 to 50 mol, and is preferably from 2 to 50 mol, and particularly preferably from 6 to 50 mol relative to 1 mol of metal atoms in a metal compound as a raw material for the metal nanoparticles, because the surface-modified metal nanoparticles can be produced substantially in the absence of a solvent. When the amount of the amine used is equal to or more than the above-described lower limit value, the metallic silver compound that is not converted into a complex is less likely to remain in complex formation, and, in the subsequent thermal decomposition, uniformity of the metal nanoparticles is increased, thereby making it possible to suppress enlargement of the particles and remaining of the metal compound that is not thermally decomposed.

The organic protective agent may contain an additional organic protective agent besides the amine. Examples of the additional organic protective agent include aliphatic monocarboxylic acids. The use of an aliphatic monocarboxylic acid tends to further improve the dispersibility of the metal nanoparticles (A)

Examples of the aliphatic monocarboxylic acid include saturated aliphatic monocarboxylic acids having 4 or more carbon atoms, such as butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, and icosanoic acid; and unsaturated aliphatic monocarboxylic acids having 8 or more carbon atoms, such as oleic acid, elaidic acid, linoleic acid, palmitoleic acid, and eicosenoic acid.

Among them, saturated or unsaturated aliphatic monocarbons having from 8 to 18 carbon atoms (in particular, octanoic acid and oleic acid) are preferred. When the carboxy groups of the aliphatic monocarboxylic acid is adsorbed on the metal nanoparticle surfaces, the saturated or unsaturated aliphatic hydrocarbon chain having from 8 to 18 carbon atoms causes a steric hindrance and thus can provide space between the metal nanoparticles, thus improving the effect of preventing aggregation of the metal nanoparticles. In addition, the aliphatic monocarboxylic acid is preferred because it is easily available and easily removed during sintering.

The amount of the aliphatic monocarboxylic acid used is, for example, approximately from 0.05 to 10 mol, preferably from 0.1 to 5 mol, and more preferably from 0.5 to 2 mol, relative to 1 mol of metal atoms in the metal compound. When the amount of the aliphatic monocarboxylic acid used is equal to or more than the above-described lower limit value, the effect of improving stability is more easily obtained. When the amount of the aliphatic monocarboxylic acid used is equal to or less than the upper limit value, the effect of the aliphatic monocarboxylic acid is sufficiently obtained while an excessive amount of the aliphatic monocarboxylic acid is unlikely to remain.

The metal nanoparticles (A) of which the surface is coated with the organic protective agent containing an amine can be produced by a known or commonly used method. The metal nanoparticles (A) can be produced, for example, through: mixing a metal compound and an organic protective agent containing an amine to produce a complex containing the metal compound and the amine (production of the complex); thermally decomposing the complex (thermal decomposition); and, as necessary, washing the reaction product (washing).

The conductive paste for bonding may contain additional conductive particles (in particular, additional metal particles) besides the metal nanoparticles (A). Among them, it is preferable to use a combination of metal particles (metal particle groups) having different average particle sizes in the conductive paste for bonding from the viewpoint that a conductive wiring or a bonded structure having a lower electric resistance value and excellent electric properties can be formed.

Examples of the shape of the additional metal particles include a spherical shape, a flat shape, and a polyhedron, and conductive particles having different shapes may be used in combination, or only conductive particles having the same shape may be used.

Preferably, the additional metal particles are spherical metal particles (B) having an average particle size of from 0.5 to 1 μm and flat metal flakes (C) having an average particle size of from 1 to 10 μm.

### Spherical Metal Particles (B)

When the spherical metal particles (B) having a larger size than that of the metal nanoparticles (A) are contained in combination with the metal nanoparticles (A), gaps between the spherical metal particles (B) having a relatively large diameter are filled with the metal nanoparticles (A) having a relatively small diameter in the formed sintered body, and thus a more dense conductive wiring or bonded structure can be formed and high bonding strength and high conductivity can be provided. Only one type of the spherical metal particles (B) may be used, or two or more types thereof may be used.

The spherical metal particles (B) may be surface-modified metal particles having a configuration in which the surfaces of the metal particles are coated with an organic protective agent. The surface-modified metal particles have excellent dispersibility in the organic solvents because the spacing between the metal particles is ensured and thus aggregation is suppressed.

Examples of the metal constituting the spherical metal particles (B) include conductive metals, and examples thereof include those exemplified and described as the metal constituting the metal nanoparticles (A). Among them, the metal particles preferably contain the same metal as that of the metal nanoparticles (A) from the viewpoint of further increasing the bonding strength, and are more preferably silver particles.

The organic protective agent is not particularly limited, and examples thereof include known or commonly used organic protective agents used as a protective agent (stabilizer) for metal particles. Examples of the organic protective agent include organic protective agents having a functional group such as a carboxy group, a hydroxy group, a carbonyl group, an amide group, an ether group, an amino group, a sulfo group, a sulfonyl group, a sulfinate group, a sulfenate group, a mercapto group, a phosphate group, or a phosphite group. Only one type of the organic protective agent may be used, or two or more types thereof may be used.

The spherical metal particles (B) have an average particle size (median diameter) of from 0.5 to 1 μm and preferably from 0.6 to 0.9 μm. The average particle size can be measured by a laser diffraction/scattering method. When two or more types of the spherical metal particles (B) are contained, the average particle size refers to an average particle size of all the spherical metal particles (B).

### Flat Metal Flakes (C)

When the flat metal flakes (C) are contained in combination with the metal nanoparticles (A), sintering of the flat metal flakes (C) themselves is combined, necking between metal particles becomes thick, and a stronger sintered body can be obtained. Only one type of the flat metal flakes (C) may be used, or two or more types thereof may be used.

The flat metal flakes (C) may be surface-modified metal flakes having a configuration in which the surfaces of the metal flakes are coated with an organic protective agent. The surface-modified metal flakes have excellent dispersibility in the organic solvents because the spacing between the metal flakes is ensured and thus aggregation is suppressed.

Examples of the metal constituting the flat metal flakes (C) include conductive metals, and examples thereof include those exemplified and described as the metal constituting the metal nanoparticles (A). Among them, the metal particles preferably contain the same metal as that of the metal nanoparticles (A) from the viewpoint of further increasing the bonding strength, and are more preferably silver particles.

The organic protective agent is not particularly limited, and examples thereof include known or commonly used organic protective agents used as a protective agent (stabilizer) for metal particles. Examples of the organic protective agent include organic protective agents having a functional group such as a carboxy group, a hydroxy group, a carbonyl group, an amide group, an ether group, an amino group, a sulfo group, a sulfonyl group, a sulfinate group, a sulfenate group, a mercapto group, a phosphate group, or a phosphite group. Only one type of the organic protective agent may be used, or two or more types thereof may be used.

The flat metal flakes (C) have an average particle size (median diameter) of from 1 to 10 μm and preferably from 2 to 5 μm. The average particle size can be measured by a laser diffraction/scattering method. When two or more types of the flat metal flakes (C) are contained, the average particle size refers to an average particle size of all the flat metal flakes (C).

A content proportion of the metal nanoparticles (A) is preferably 5 mass % or more, and more preferably 10 mass % or more in 100 mass % of all conductive metal particles contained in the conductive paste for bonding. When the content proportion is 5 mass % or more, a more dense conductive wiring or bonded structure can be formed. The content proportion is preferably 50 mass % or less, more preferably 30 mass % or less, and even more preferably 20 mass % or less. When the content proportion is 50 mass % or less, the amounts of the spherical metal particles (B) and the flat metal flakes (C) blended can be sufficient.

A content proportion of the spherical metal particles (B) is preferably 30 mass % or more, more preferably 40 mass % or more, and even more preferably more than 50 mass % in 100 mass % of all the conductive metal particles contained in the conductive paste for bonding. When the content proportion is 30 mass % or more, the effect due to blending the spherical metal particles (B) is more easily obtained. The content proportion is preferably 85 mass % or less, more preferably 80 mass % or less, and even more preferably 70 mass % or less. When the content proportion is 85 mass % or less, the amounts of the metal nanoparticles (A) and the flat metal flakes (C) blended can be sufficient.

A content proportion of the flat metal flakes (C) is preferably 10 mass % or more, and more preferably 15 mass % or more in 100 mass % of all the conductive metal particles contained in the conductive paste for bonding. When the content proportion is 10 mass % or more, the effect due to blending the flat metal flakes (C) is more easily obtained. The content proportion is preferably 65 mass % or less, more preferably 50 mass % or less, and even more preferably 40 mass % or less. When the content proportion is 65 mass % or less, the amounts of the metal nanoparticles (A) and the spherical metal particles (B) blended can be sufficient.

A total content proportion of the metal nanoparticles (A), the spherical metal particles (B), and the flat metal flakes (C) is preferably 70 mass % or more, more preferably 80 mass % or more, even more preferably 90 mass % or more, and particularly preferably 95 mass % or more, relative to a total amount of 100 mass % of the conductive particles contained in the conductive paste for bonding. When the content proportion is 70 mass % or more, the dispersibility of the metal particles is more excellent, and the continuous discharge stability and the storage stability are more excellent.

### Conductive Paste for Bonding

A content proportion of the metal particles in the conductive paste for bonding is preferably from 70 to 99.5 mass %, more preferably from 80 to 98 mass %, and even more preferably 85 to 95 mass % relative to a total amount of 100 mass % of the conductive paste for bonding. When the content proportion is within the above range, the dispersibility of the metal particles is more excellent, and the continuous discharge stability and the storage stability are more excellent. Preferably, a total content proportion of the metal nanoparticles (A), the spherical metal particles (B), and the flat metal flakes (C) in the conductive paste for bonding is within the above range.

A content proportion of the dispersion medium (particularly, the organic solvents) in the conductive paste for bonding is preferably from 0.5 to 30 mass %. more preferably from 2 to 20 mass %, and even more preferably from 5 to 15 mass % relative to the total amount of 100 mass % of the conductive paste for bonding. When the content proportion is within the above range, the dispersibility of the metal particles is more excellent. The total content proportion of the organic solvent (a), the organic solvent (b), and the organic solvent (c) in the conductive paste for bonding is preferably within the above range.

A total content proportion of the metal particles and the dispersion medium in the conductive paste for bonding is preferably 70 mass % or more, more preferably 80 mass % or more, even more preferably 90 mass % or more, and particularly preferably 95 mass % or more relative to the total amount of 100 mass % of the conductive paste for bonding.

The conductive paste for bonding may contain an additional component besides the metal particles and the dispersion medium. The conductive paste for bonding may contain, for example, an adhesive or an additive (for example, a polymer compound having a molecular weight of 10000 or more, such as an epoxy resin, a silicone resin, or an acrylic resin), provided that a content proportion thereof is, for example, 10 mass % or less, preferably 5 mass % or less, more preferably 3 mass % or less, and particularly preferably 1 mass % or less relative to the total amount of 100 mass % of the conductive paste for bonding. Therefore, according to the conductive paste for bonding, a non-conductive component derived from the polymer compound does not inhibit interaction between the metal particles or between the metal particles and a substrate, and a conductive wiring or bonded structure having excellent conductivity, which has an electric resistance value of, for example, 10×10⁻⁶ Ω·cm or less, preferably 9.0×10⁻⁶ Ω·cm or less, more preferably 8.5×10⁻⁶ Ω·cm or less, and even more preferably 7.0×10⁻⁶ Ω·cm or less, can be formed.

The conductive paste for bonding according to an embodiment of the present disclosure contains, as a dispersion medium for dispersing the metal nanoparticles (A), the organic solvent (a) that is a relatively highly polar solvent and the organic solvent (c) that is a relatively low polar solvent, and thus the dispersibility of the metal nanoparticles (A) is excellent, separation between the metal particles and the dispersion medium is less likely to occur, and generation of voids during sintering can be suppressed. In addition, by blending the organic solvent (b) having an intermediate polarity, the miscibility between the organic solvent (a) and the organic solvent (c) is improved, the separation between the organic solvents is less likely to occur, and the continuous discharge stability and the storage stability are more excellent.

### Sintered Body

A sintered body can be formed by applying the conductive paste for bonding according to an embodiment of the present disclosure to a substrate by, for example, a printing method (specifically, a dispenser printing method, a mask printing method, a screen printing method, an inkjet printing method, or the like), and then sintering the substrate, and a conductive wiring and a bonded structure can be formed. Above all, the conductive paste for bonding is preferably printed by a dispenser printing method from the viewpoint of excellent continuous discharge stability.

The sintering temperature is, for example, 150° C. or higher and lower than 300° C., and preferably from 170 to 250° C. The sintering time is, for example, from 0.1 to 2 hours, and preferably from 0.5 to 1 hours.

The sintering may be performed in one of an air atmosphere, a nitrogen atmosphere, an argon atmosphere, and the like. Among them, it is preferable to perform the sintering in an air atmosphere from the viewpoint of economy and producing a conductive wiring or bonded structure having a lower electric resistance value.

The thickness of the conductive paste for bonding applied onto the substrate is in a range such that a thickness of the conductive wiring and the bonded structure formed by the above method is, for example, from 15 to 400 μm, preferably from 20 to 250 μm, and more preferably from 40 to 200 μm.

Examples of the substrate on which the conductive wiring and the bonded structure are formed include a ceramic substrate, an SiC substrate, a gallium nitride substrate, a metal substrate, a glass epoxy substrate, a BT resin substrate, a glass substrate, and a resin substrate. The shape of the conductive wiring and the bonded structure is not particularly limited as long as the conductive wiring and the bonded structure have a shape capable of connecting electronic elements.

Furthermore, in the sintered body (for example, conductive wiring or bonded structure) formed on the substrate using the conductive paste for bonding, conductive particles are densely assembled by sintering, and the conductive particles are melted with each other, and thus excellent bonding strength to the substrate can be exhibited. For example, the bonding strength (in accordance with JIS Z3198) when a silver-plated copper substrate and a silver-plated Si chip are bonded is preferably 10 MPa or more, more preferably 25 MPa or more, even more preferably 30 MPa or more, and particularly preferably 40 MPa or more.

A void ratio of the sintered body (for example, conductive wiring or bonded structure) formed on the substrate using the conductive paste for bonding, as measured using a scanning acoustic tomograph (SAT), is preferably 15% or less, and more preferably less than 8%. When the void ratio is 15% or less, the bonding strength is further increased. A high void ratio indicates a large number of void spaces in a joint interface or the like, and a heat transfer area with a portion to be bonded in a bonded body is considered to decrease. When a semiconductor is in operation, it is fatal that the heat transfer area is decreased in releasing heat, and there is a high possibility that a heat spot is generated, leading to a failure. Specifically, the void ratio can be measured by the method which will be described in the Examples.

Since the conductive paste for bonding has the above properties, for example, the conductive paste for bonding can be favorably used for the purpose of manufacturing an electronic component (for example, a power semiconductor module, an LED module, or the like) using a printing method.

Each aspect disclosed in the present specification can be combined with any other feature disclosed herein. Note that each of the configurations, combinations thereof, or the like in each of the embodiments are examples, and additions, omissions, replacements, and other changes to the configurations may be made as appropriate without departing from the spirit of the present disclosure. In addition, each aspect of the invention according to the present disclosure is not limited by the embodiments or the following examples but is limited only by the claims.

### EXAMPLES

An embodiment of the present disclosure will be described in further detail below based on examples.

### Average Particle Size of Metal Nanoparticles (A)

Hereinafter, the average particle size (median diameter) of the metal nanoparticles (A) was measured by the following method.

A suspension containing the surface-modified silver nanoparticles produced in Preparation Example 1 was observed with a transmission electron microscope. The observation was performed at a magnification of 100000 times for 4 fields×50. In addition, the observation site was a site where large and small particles coexisted. The number particle size distribution was determined by image analysis. The number particle size distribution of the particles was converted to a volume particle size distribution using a known conversion formula on the assumption that the aspect ratio was 1. The average particle size (median diameter) was determined from the particle size distribution, and was defined as the average particle size of the metal nanoparticles (A).

Average particle sizes of spherical metal particles (B) and flat metal flakes (C)

The average particle sizes are values measured by a laser diffraction/scattering method.

The metal particles and the solvents used are as follows.

### [Metal Particles]

Surface-modified silver nanoparticles (Adjustment Example 1): average particle size (median diameter) of 50 nm
AG-2-8F: trade name “AG-2-8F” available from DOWA Electronics Co., Ltd., spherical silver particles, average particle size (median diameter) of 0.8 μm
41-104: trade name “41-104” available from Technic, flat-shaped silver flakes, average particle size (median diameter) of 3.3 μm

### [Solvent (I): Highly Polar Solvent]

Pinacol: δ of 10.7, boiling point of 172° C., available from Tokyo Chemical Industry Co., Ltd.
Tetramethylurea: δ of 10.6, boiling point of 177° C., available from Daicel Corporation
3-Methoxybutanol: δ of 10.6, boiling point of 161° C., available from Daicel Corporation
1-Methylcyclohexanol: δ of 10.4, boiling point of 155° C., available from Tokyo Chemical Industry Co., Ltd.

### [Solvent (II): Medium Polar Solvent]

Tripropylene glycol monomethyl ether: δ of 9.4, boiling point 243° C., available from Andoh Parachemie Co., Ltd.
Dihydroterpineol: δ of 9.0, boiling point of 210° C., available from Nippon Terpene Chemical Co., Ltd.
Propylene glycol monobutyl ether: δ of 9.0, boiling point 170° C., available from Tokyo Chemical Industry Co., Ltd.

1-Nonanol: δ of 9.8, boiling point of 214° C., available from Tokyo Chemical Industry Co., Ltd.
1-Dodecanol: δ of 9.3, boiling point of 262° C., available from Tokyo Chemical Industry Co., Ltd.

### [Solvent (III): Low Polar Solvent]

Dibutyl carbitol: δ of 8.3, boiling point of 255° C., available from Tokyo Chemical Industry Co., Ltd.
Tetradecane: δ of 7.9, boiling point of 254° C., available from Tokyo Chemical Industry Co., Ltd.
Hexadecane: δ of 8.0, boiling point of 287° C., available from Tokyo Chemical Industry Co., Ltd.
Dipropylene glycol methyl-n-propyl ether: δ of 8.2, boiling point of 203° C., available from Daicel Corporation

### Preparation Example 1 (Preparation of Surface-Modified Silver Nanoparticles)

Silver oxalate (molecular weight: 303.78) was produced from silver nitrate (available from FUJIFILM Wako Pure Chemical Corporation) and oxalic acid dihydrate (available from FUJIFILM Wako Pure Chemical Corporation).

Then, 40.0 g (0.1317 mol) of the silver oxalate was charged to a 500-mL flask, and 60 g of n-butanol was added thereto to prepare a slurry of silver oxalate in n-butanol.

To the obtained slurry, a liquid amine mixture of 115.58 g (1.5802 mol) of n-butylamine (molecular weight: 73.14, reagent available from Tokyo Chemical Industry Co., Ltd.), 51.06 g (0.3950 mol) of 2-ethylhexylamine (molecular weight: 129.25, reagent available from FUJIFILM Wako Pure Chemical Corporation), and 17.02 g (0.1317 mol) of n-octylamine (molecular weight: 129.25, reagent available from Tokyo Chemical Industry Co., Ltd.) was added dropwise at 30° C.

After the dropwise addition, the mixture was stirred at 30° C. for 1 hour to allow a complex formation reaction between silver oxalate and the amines to proceed.

After the formation of the silver oxalate-amine complex, the silver oxalate-amine complex was thermally decomposed by heating at 110° C. for 1 hour to obtain a dark blue suspension containing surface-modified silver nanoparticles.

The resulting suspension was cooled, and then 120 g of methanol (available from Wako Pure Chemical Industries, Ltd.) was added thereto and stirred. Then, the surface-modified silver nanoparticles were precipitated by centrifugation, and the supernatant was removed. Subsequently, 120 g of dibutyl carbitol (diethylene glycol dibutyl ether) was added and stirred. Then, the surface-modified silver nanoparticles were precipitated by centrifugation, and the supernatant was removed. Surface-modified silver nanoparticles, in a wet state, containing dibutyl carbitol were thus obtained. The content of silver existing as the surface-modified silver nanoparticles in the total amount (100 mass %) of the wet surface-modified silver nanoparticles was 86.5 mass %, from measurement results by a thermal balance using “TG/DTA 6300” available from SII. That is, the wet surface-modified silver nanoparticles contained 13.5 mass % in total of amine and dibutyl carbitol existing as the organic protective agent for surface modification. The average particle size (median diameter) of the wet surface-modified silver nanoparticles was 50 nm.

### Example 1 (Preparation of Conductive Paste for Bonding)

The trade name “41-104” (25.50 g), AG-2-8F (59.50 g), pinacol (3.48 g), tripropylene glycol methyl ether (3.48 g), and dibutyl carbitol (1.14 g) were added and mixed with a rotating and revolving mixer (ARE-310, available from THINKY) to prepare a liquid A.

To 17.34 g of the wet surface-modified silver nanoparticles (containing 13.5 mass % of dibutyl carbitol) obtained in Preparation Example 1, 90.32 g of the liquid A was added. The mixture was mixed with a rotating and revolving mixer (ARE-310, available from THINKY) to obtain a blackish gray conductive paste for bonding (1).

### Examples 2 to 6 and Comparative Examples 1 to 8

Conductive pastes for bonding were produced in the same manner as in Example 1 except that the formulation was changed to the respective one shown in Table 1. The numerical value of each component shown in Table 1 represents “parts by mass”.

### Evaluation

The conductive pastes for bonding obtained in the Examples and the Comparative Examples were evaluated as follows. The results are shown in the table.

The instruments used in the evaluation are as follows.

### Equipment

Syringe

Trade name “Clear Syringe PSY-10E-M” available from Musashi Engineering, Inc.
Nozzle

Trade name “Precision Nozzle Φ 0.4 mm Luer Lock HN-0.4N” available from Musashi Engineering, Inc.
Dispenser

Trade name “Desktop Coating Robot SHOTMASTER200DS” available from Musashi Engineering, Inc.
Dispenser controller

Trade name “ML-5000XII” available from Musashi Engineering, Inc.
Adapter tube

Trade name “AT-10E-H-1.0M” available from Musashi Engineering, Inc.
Sintering furnace

Trade name “VS-320” available from Budatec
Universal bond tester

Trade name “Die Shear Tester SERIES4000” available from Nordson DAGE
Scanning acoustic tomograph

Trade name “FineSAT FS300II” available from Hitachi High-Tech Corporation
Scanning electron microscope (SEM)

Trade name “JEOL JSM-F100” available from JEOL Ltd.
Milling device

Trade name “ArBlade5000” available from Hitachi, Ltd.
(1) Continuous Discharge Stability

Each of the conductive pastes for bonding (10 mL) obtained in the Examples and the Comparative Examples was filled in a syringe, and a nozzle and an adapter tube were attached to the syringe. The syringe was set in a dispenser, and the paste was shot on trial at a pressure of 0.2 MPa until continuous discharge was possible, and then 400 shots thereof were continuously discharged onto a plate. The injection time was adjusted in accordance with the viscosity of the paste, continuous discharge was performed until the filled paste was exhausted, and the discharge weight of the paste per 400 shots was measured. Then, the conductive pastes whose discharge amount per 400 shots was ±20% or less were evaluated as ○, the conductive pastes whose discharge amount per 400 shots was more than ±20% and 30% or less were evaluated as A, and the conductive pastes whose discharge amount per 400 shots was more than ±30% were evaluated as x.
(2) Continuous Discharge Stability After Refrigerated Storage

The conductive pastes for bonding obtained in the Examples and the Comparative Examples were stored in a refrigerator at 0 to 5° C. for 7 days, and then cooled to room temperature. The conductive pastes were subjected to evaluation of continuous discharge stability after refrigerated storage in the same manner as in the evaluation of continuous discharge stability.
(3) Die shear strength

Each of the conductive pastes for bonding obtained in the Examples and the Comparative Examples was applied to an Ag-plated substrate (1) (1 mm thick copper substrate on which a 5 μm thick Ni-Player was formed by electroless plating, a 0.3 μm thick pure Pd layer was further formed thereon by electrolytic plating, and a 1 μm thick semi-bright silver layer was formed on the outermost surface by electrolytic plating) by a dispenser printing method to form a coating film.

Subsequently, a Si dummy chip (2) (chip size: 3 mm ×3 mm, Si thickness: 675 μm, Si dummy chip in which a Ti layer (0.2 μm) and an Ag layer (1 μm) were formed on Si by sputtering) whose bonding surface was Ag-sputtered was mounted on the formed coating film at a load of 0.1 kgf. The sample in which the Si dummy chip was mounted on the substrate via the conductive paste for bonding was subjected to a temperature increase from 25° C. to 200° C. at a temperature increase rate of 5° C./min in an air atmosphere using a sintering furnace, sintered by heating at 200° C. for 60 minutes to prepare a sample (substrate (1)/sintered conductive paste for bonding/dummy chip (2)).

For the obtained sample (n=4), the bonding strength between the substrate (1) and the dummy chip (2) was measured under the room temperature condition by a method in accordance with JIS Z3198 using a universal bond tester to evaluate bonding property.
(4) SAT evaluation

For the samples produced in the evaluation of the die shear strength, the peeling state of the joint interface was observed using a scanning acoustic tomograph and a probe for reflection method of 25 MHz. The image of this observation result was divided into 100 parts, and a portion where the length of the long side of a white portion in each enlarged image was 100 μm or more was defined as a void. In each of the 100 divided images, an area of the white portions by image processing was defined as a void ratio, and an average value of the void ratios in all the divided images was defined as a void ratio. The samples having a void ratio of less than 8% were evaluated as ○, the samples having a void ratio of 8% or more and less than 30% were evaluated as Δ, and the samples having a void ratio of 30% or more were evaluated as x.
(5) SEM image result

For the samples produced in the evaluation of the die shear strength, the center of the chip was cut and its cross section was polished using a milling device. Subsequently, the joint cross section was observed by adjusting the magnification using a scanning electron microscope.

TABLE 1

| | | | | | Exam- | Exam- | Exam- | Exam- | Exam- | Exam- | Comparative | Comparative |
|---|---|---|---|---|---|---|---|---|---|---|---|---|
| Formulation | | | δ | B.P. | ple 1 | ple 2 | ple 3 | ple 4 | ple 5 | ple 6 | Example 1 | Example 2 |
| Dispersion | Solvent | Pinacol | 10.7 | 172 | 3.48 | — | — | 3.48 | — | — | — | 4.50 |
| medium | (I) | Tetramethylurea | 10.6 | 177 | — | 3.48 | — | — | — | — | — | — |
| | | 3-Methoxybutanol | 10.6 | 161 | — | — | 3.48 | — | 3.48 | 3.48 | — | — |
| | | 1-Methylcyclohexanol | 10.4 | 155 | — | — | — | — | — | — | — | — |
| | Solvent | Tripropylene glycol | 9.4 | 243 | 3.48 | 3.48 | 3.48 | — | — | — | — | — |
| | (II) | monomethyl ether | | | | | | | | | | |
| | | Dihydroterpineol | 9.0 | 210 | — | — | — | 3.48 | 1.25 | 3.48 | — | — |
| | | Propylene glycol | 9.0 | 170 | — | — | — | — | — | — | — | — |
| | | monobutyl ether | | | | | | | | | | |
| | | 1-Nonanol | 9.8 | 214 | — | — | — | — | — | — | — | — |
| | | 1-Dodecanol | 9.3 | 262 | — | — | — | — | — | — | — | — |
| | Solvent | Dibutyl carbitol | 8.3 | 255 | 3.48 | 3.48 | 3.48 | 3.48 | — | — | 9.12 | 4.50 |
| | (III) | Tetradecane | 7.9 | 254 | — | — | — | — | 3.48 | — | — | — |
| | | Hexadecane | 8.0 | 287 | — | — | — | — | — | 3.48 | — | — |
| | | Dipropylene glycol | 8.2 | 203 | — | — | — | — | — | — | — | — |
| | | methyl-n-propyl ether | | | | | | | | | | |

| | | | | | | | | | |
|---|---|---|---|---|---|---|---|---|---|
| | Total of dispersion media | 10.44 | 10.44 | 10.44 | 10.44 | 8.21 | 10.44 | 9.12 | 9.00 |
| Silver | Surface-modified silver nanoparticles | 15 | 15 | 15 | 15 | 15 | 15 | 15 | 15 |
| Particles | (Adjustment Example 1) | | | | | | | | |
| | AG-2-8F | 59.5 | 59.5 | 59.5 | 59.5 | 59.5 | 59.5 | 59.5 | 59.5 |
| | 41-104 | 25.5 | 25.5 | 25.5 | 25.5 | 25.5 | 25.5 | 25.5 | 25.5 |
| | Total of silver particles | 100 | 100 | 100 | 100 | 100 | 100 | 100 | 100 |
| Evaluation | Continuous discharge stability | ∘ | ∘ | ∘ | ∘ | ∘ | ∘ | x | Δ |
| | Continuous discharge stability | ∘ | ∘ | ∘ | ∘ | ∘ | ∘ | — | x |
| | after refrigerated storage | | | | | | | | |
| | Die shear strength [MPa] | 59.6 | 46.0 | 59.5 | 58.3 | 57.5 | 66.1 | 53.9 | 53.6 |
| | SAT evaluation | ∘ | ∘ | ∘ | ∘ | ∘ | ∘ | ∘ | ∘ |

| | | | | | Comparative | Comparative | Comparative | Comparative | Comparative | Comparative |
|---|---|---|---|---|---|---|---|---|---|---|
| Formulation | | | δ | B.P. | Example 3 | Example 4 | Example 5 | Example 6 | Example 7 | Example 8 |
| Dispersion | Solvent | Pinacol | 10.7 | 172 | — | 5.22 | — | — | — | 3.48 |
| medium | (I) | Tetramethylurea | 10.6 | 177 | — | — | — | — | — | — |
| | | 3-Methoxybutanol | 10.6 | 161 | — | — | — | — | — | — |
| | | 1-Methylcyclohexanol | 10.4 | 155 | 5.95 | — | — | — | — | — |
| | Solvent | Tripropylene glycol | 9.4 | 243 | — | 5.22 | — | — | — | 3.48 |
| | (II) | monomethyl ether | | | | | | | | |
| | | Dihydroterpineol | 9.0 | 210 | — | — | — | — | — | — |
| | | Propylene glycol | 9.0 | 170 | — | — | 5.10 | — | — | — |
| | | monobutyl ether | | | | | | | | |
| | | 1-Nonanol | 9.8 | 214 | — | — | — | 5.10 | — | — |
| | | 1-Dodecanol | 9.3 | 262 | — | — | — | — | 5.10 | — |
| | Solvent | Dibutyl carbitol | 8.3 | 255 | 2.38 | — | 2.38 | 2.38 | 2.38 | — |
| | (III) | Tetradecane | 7.9 | 254 | — | — | — | — | — | — |
| | | Hexadecane | 8.0 | 287 | — | — | — | — | — | — |
| | | Dipropylene glycol | 8.2 | 203 | — | — | — | — | — | 3.48 |
| | | methyl-n-propyl ether | | | | | | | | |

| | | | | | | | |
|---|---|---|---|---|---|---|---|
| | Total of dispersion media | 8.33 | 10.44 | 7.48 | 7.48 | 7.48 | 10.44 |
| Silver | Surface-modified silver nanoparticles | 15 | 15 | 15 | 15 | 15 | 15 |
| Particles | (Adjustment Example 1) | | | | | | |
| | AG-2-8F | 59.5 | 59.5 | 59.5 | 59.5 | 59.5 | 59.5 |
| | 41-104 | 25.5 | 25.5 | 25.5 | 25.5 | 25.5 | 25.5 |
| | Total of silver particles | 100 | 100 | 100 | 100 | 100 | 100 |
| Evaluation | Continuous discharge stability | Δ | Δ | x | x | x | — |
| | Continuous discharge stability | x | Δ | — | — | — | — |
| | after refrigerated storage | | | | | | |
| | Die shear strength [MPa] | 47.9 | 45.3 | 64.1 | 68.2 | 32.5 | 47.3 |
| | SAT evaluation | x | Δ | Δ | x | x | Δ |

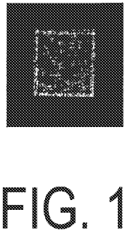

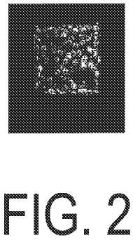

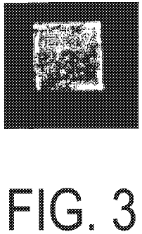

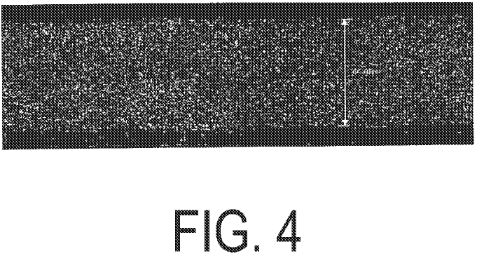

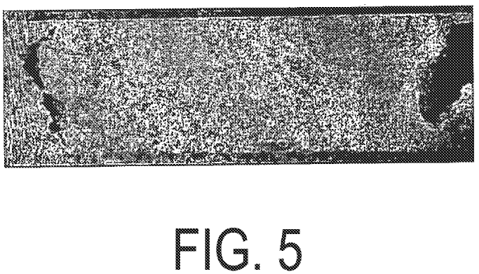

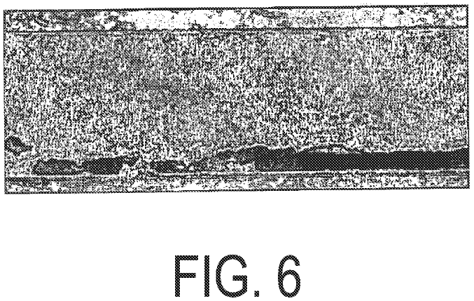

As shown in Table 1, the conductive pastes for bonding of the Examples were excellent in continuous discharge stability and continuous discharge stability after refrigerated storage, and, in the SAT evaluation, suppressed generation of voids and evaluated to have high die shear strength. On the other hand, when only the solvent (III), as a low polar solvent, was used as the dispersion medium, separation between the silver particles and the organic solvent occurred, and the continuous discharge stability was poor (Comparative Example 1). When the solvent (I) as a highly polar solvent and the solvent (III) as a low polar solvent were used in combination as the dispersion medium, separation between the silver particles and the organic solvents occurred during low-temperature storage, and the low-temperature storage stability was poor (Comparative Examples 2 and 3). When the solvent (I) and the solvent (II) as medium polar solvents were used in combination, since the solvent (III) was not blended, clear separation could not be confirmed during low-temperature storage, but the continuous discharge stability was insufficient (Comparative Example 4). When the solvent (III) and the solvent (II) as medium polar solvents were used in combination, since the solvent (I) was not blended, the dispersibility of the silver particles was poor, the continuous discharge stability and the suppression of voids were insufficient, and the die shear strength was weak (Comparative Examples 5 to 7). Even in the case where the solvent (I), the solvent (II), and the solvent (III) were used in combination, when the solvent (III) did not satisfy the relationship of Formula (3) in terms of boiling point, the volatilization rate of the solvents could not be suppressed, and the suppression of voids was insufficient (Comparative Example 8). In addition, as shown in FIGS. 1 to 3, as compared with Example 1 in which the SAT evaluation was ○, a large number of voids were confirmed in Comparative Example 5 in which the SAT evaluation was Δ and Comparative Example 7 in which the SAT evaluation was x. In addition, as shown in FIGS. 4 to 6, according to the SEM observation, large void spaces were not confirmed inside the bonded body in Example 1, whereas large void spaces were confirmed inside the bonded bodies in Comparative Examples 5 and 7.

Hereinafter, variations of the invention according to the present disclosure will be described.
[Supplementary Note 1] A conductive paste for bonding containing: metal nanoparticles (A) having an average particle size of 1 nm or more and less than 100 nm, and a dispersion medium containing an organic solvent (a), an organic solvent (b), and an organic solvent (c),
Wherein
the metal nanoparticles (A) are coated on surfaces thereof with an organic protective agent containing an amine and dispersed in the dispersion medium, and
the organic solvent (a), the organic solvent (b), and the organic solvent (c) are different compounds and satisfy the following formulas (1) to (6):

$$150 ° C . \leq Ta \leq 250 ° C . \qquad ( 1 )$$

$$150 ° C . \leq Tb \leq 250 ° C . \qquad ( 2 )$$

$$250 ° C . \leq Tc \leq 350 ° C . \qquad ( 3 )$$

$$δ a \geq 10. \qquad ( 4 )$$

$$δ c \leq 9. \qquad ( 5 )$$

$$δ c \leq δ b \leq δ a \qquad ( 6 )$$

wherein Ta to Tc represent boiling points of the organic solvents (a) to (c), respectively, and δa to δc represent Hansen solubility parameters of the organic solvents (a) to (c), respectively.
[Supplementary Note 2] The conductive paste for bonding according to Supplementary Note 1, further containing spherical metal particles (B) having an average particle size of from 0.5 to 1 μm and flat metal flakes (C) having an average particle size of from 1 to 10 μm.
[Supplementary Note 3] The conductive paste for bonding according to Supplementary Note 2, wherein a total content proportion of the metal nanoparticles (A), the spherical metal particles (B), and the flat metal flakes (C) in the conductive paste for bonding is from 80 to 99.5 mass %.
[Supplementary Note 4] The conductive paste for bonding according to Supplementary Note 2 or 3, wherein a metal constituting the spherical metal particles (B) is silver.
[Supplementary Note 5] The conductive paste for bonding according to any one of Supplementary Notes 2 to 4,
wherein the spherical metal particles (B) have an average particle size of from 0.6 to 0.9 μm.
[Supplementary Note 6] The conductive paste for bonding according to any one of Supplementary Notes 2 to 5, wherein a metal constituting the flat metal flakes (C) is silver.
[Supplementary Note 7] The conductive paste for bonding according to any one of Supplementary Notes 2 to 6, wherein the flat metal flakes (C) have an average particle size of from 2 to 5 μm.
[Supplementary Note 8] The conductive paste for bonding according to any one of Supplementary Notes 2 to 7, wherein a content proportion of the spherical metal particles (B) is 30 mass % or more (preferably 40 mass % or more, and more preferably more than 50 mass %) in 100 mass % of all conductive metal particles contained in the conductive paste for bonding.
[Supplementary Note 9] The conductive paste for bonding according to any one of Supplementary Notes 2 to 8, wherein a content proportion of the spherical metal particles (B) is 85 mass % or less (preferably 80 mass % or less, and more preferably 70 mass % or less) in 100 mass % of all the conductive metal particles contained in the conductive pastes for bonding.
[Supplementary Note 10] The conductive paste for bonding according to any one of Supplementary Notes 2 to 9, wherein a content proportion of the flat metal flakes (C) is 10 mass % or more (preferably 15 mass % or more) in 100 mass % of all the conductive metal particles contained in the conductive pastes for bonding.
[Supplementary Note 11] The conductive paste for bonding according to any one of Supplementary Notes 2 to 10,
wherein a content proportion of the flat metal flakes (C) is 65 mass % or less (preferably 50 mass % or less, and more preferably 40 mass % or less) in 100 mass % of all the conductive metal particles contained in the conductive pastes for bonding.
[Supplementary Note 12] The conductive paste for bonding according to any one of Supplementary Notes 2 to 11, wherein a total content proportion of the metal nanoparticles (A), the spherical metal particles (B), and the flat metal flakes (C) is 70 mass % or more (preferably 80 mass % or more, more preferably 90 mass % or more, and even more preferably 95 mass % or more) relative to a total amount of 100 mass % of conductive particles contained in the conductive pastes for bonding.
[Supplementary Note 13] The conductive paste for bonding according to any one of Supplementary Notes 1 to 12, wherein a content proportion of the metal nanoparticles (A) in all metal particles contained in the conductive paste for bonding is 50 mass % or less (preferably 30 mass % or less, and more preferably 20 mass % or less).
[Supplementary Note 14] The conductive paste for bonding according to any one of Supplementary Notes 1 to 13, wherein a content proportion of the metal nanoparticles (A) is 5 mass % or more (preferably 10 mass % or more) in 100 mass % of all the conductive metal particles contained in the conductive pastes for bonding.
[Supplementary Note 15] The conductive paste for bonding according to any one of Supplementary Notes 1 to 14,
wherein the organic protective agent contains, as the amine, an aliphatic hydrocarbon monoamine (1) including an aliphatic hydrocarbon group and one amino group, the aliphatic hydrocarbon group having 6 or more carbon atoms in total, and the organic protective agent further contains at least one of an aliphatic hydrocarbon monoamine (2) or an aliphatic hydrocarbon diamine (3), the aliphatic hydrocarbon monoamine (2) including an aliphatic hydrocarbon group and one amino group, the aliphatic hydrocarbon group having 5 or less carbon atoms in total, and the aliphatic hydrocarbon diamine (3) including an aliphatic hydrocarbon group and two amino groups, the aliphatic hydrocarbon group having 8 or less carbon atoms in total.
[Supplementary Note 16] The conductive paste for bonding according to any one of Supplementary Notes 1 to 15, further containing an organic solvent besides the organic solvent (a), the organic solvent (b), and the organic solvent (C).
[Supplementary Note 17] The conductive paste for bonding according to any one of Supplementary Notes 1 to 16, wherein the organic solvent (a), the organic solvent (b), and the organic solvent (c) are uniformly dissolved at an ordinary temperature without phase separation.
[Supplementary Note 18] The conductive paste for bonding according to any one of Supplementary Notes 1 to 17, wherein the boiling point Ta of the organic solvent (a) satisfies 150° C.<Ta<250° C. (preferably 155° C.≤Ta≤220° C., and more preferably 160° C.≤Ta≤200° C.).
[Supplementary Note 19] The conductive paste for bonding according to any one of Supplementary Notes 1 to 18, wherein an SP value δa of the organic solvent (a) is 10.3 or more (preferably 10.4 or more).
[Supplementary Note 20] The conductive paste for bonding according to any one of Supplementary Notes 1 to 19, wherein the SP value δa of the organic solvent (a) is 16.0 or less (preferably 15.0 or less).
[Supplementary Note 21] The conductive paste for bonding according to any one of Supplementary Notes 1 to 20, wherein the organic solvent (a) is one or more selected from the group consisting of an alcohol solvent, a urea-based solvent, and an aprotic polar solvent.
[Supplementary Note 22] The conductive paste for bonding according to any one of Supplementary Notes 1 to 21, wherein the boiling point Tb of the organic solvent (b) satisfies 150° C.<Tb<250° C. (preferably 180° C.≤Tb≤248° C., and more preferably 200° C.≤Tb≤245° C.).
[Supplementary Note 23] The conductive paste for bonding according to any one of Supplementary Notes 1 to 22, wherein an SP value δb of the organic solvent (b) is from 8.0 to 12.0 (preferably from 8.5 to 11.0, and more preferably from 9.0 to 10.5).
[Supplementary Note 24] The conductive paste for bonding according to any one of Supplementary Notes 1 to 23, wherein the organic solvent (b) is one or more selected from the group consisting of an alcohol solvent, an ester solvent, a ketone solvent, and an amine-based solvent.
[Supplementary Note 25] The conductive paste for bonding according to any one of Supplementary Notes 1 to 24, wherein the boiling point Tb of the organic solvent (b) is higher than the boiling point Ta of the organic solvent (a).
[Supplementary Note 26] The conductive paste for bonding according to Supplementary Note 25, wherein a temperature difference [Tb−Ta] between the boiling point Tb of the organic solvent (b) and the boiling point Ta of the organic solvent (a) is 2° C. or more (preferably 5° C. or more, and more preferably 10° C. or more).
[Supplementary Note 27] The conductive paste for bonding according to any one of Supplementary Notes 1 to 26, wherein the boiling point Tc of the organic solvent (c) satisfies 250° C.<Tc<350° C. (preferably 250° C.<Tc≤320° C., and more preferably 250° C.<Tc≤300° C.)
[Supplementary Note 28] The conductive paste for bonding according to any one of Supplementary Notes 1 to 27, wherein an SP value dc of the organic solvent (c) is 8.7 or less (more preferably 8.5 or less).
[Supplementary Note 29] The conductive paste for bonding according to any one of Supplementary Notes 1 to 28, wherein the SP value δc of the organic solvent (c) is 6.0 or more (preferably 7.0 or more).
[Supplementary Note 30] The conductive paste for bonding according to any one of Supplementary Notes 1 to 29, wherein the organic solvent (c) is one or more selected from the group consisting of an ether solvent, an alkane solvent, and an ester solvent.
[Supplementary Note 31] The conductive paste for bonding according to any one of Supplementary Notes 1 to 30, wherein the boiling point Tc of the organic solvent (c) is higher than the boiling point Tb of the organic solvent (b).
[Supplementary Note 32] The conductive paste for bonding according to Supplementary Note 31, wherein a temperature difference [Tc−Tb] between the boiling point Tc of the organic solvent (c) and the boiling point Tb of the organic solvent (b) is 2° C. or more (preferably 6° C. or more, and more preferably 10° C. or more).
[Supplementary Note 33] The conductive paste for bonding according to any one of Supplementary Notes 1 to 32, wherein the boiling point Tc of the organic solvent (c) is higher than the boiling point Ta of the organic solvent (a).
[Supplementary Note 34] The conductive paste for bonding according to Supplementary Note 33, wherein a temperature difference [Tc−Ta] between the boiling point Tb of the organic solvent (c) and the boiling point Tb of the organic solvent (a) is 30° C. or more (preferably 50° C. or more, and more preferably 60° C. or more)
[Supplementary Note 35] The conductive paste for bonding according to any one of Supplementary Notes 1 to 34, wherein the SP value δb of the organic solvent (b) is higher than the SP value δc of the organic solvent (c).
[Supplementary Note 36] The conductive paste for bonding according to Supplementary Note 35, wherein a difference [δb−δc] between the SP value δb of the organic solvent (b) and the SP value δc of the organic solvent (c) is 0.1 or more (preferably 0.2 or more, and more preferably 0.5 or more).
[Supplementary Note 37] The conductive paste for bonding according to Supplementary Note 35 or 36, wherein the difference [δb−δc] between the SP value δb of the organic solvent (b) and the SP value δc of the organic solvent (c) is 2.0 or less (preferably 1.5 or less, and more preferably 1.3 or less).
[Supplementary Note 38] The conductive paste for bonding according to any one of Supplementary Notes 1 to 37, wherein the SP value δa of the organic solvent (a) is higher than the SP value δb of the organic solvent (b).
[Supplementary Note 39] The conductive paste for bonding according to Supplementary Note 38, wherein a difference [δa−δb] between the SP value δa of the organic solvent (a) and the SP value δb of the organic solvent (b) is 0.1 or more (preferably 0.2 or more, and more preferably 0.5 or more).
[Supplementary Note 40] The conductive paste for bonding according to Supplementary Note 38 or 39, wherein the difference [δa−δb] between the SP value δa of the organic solvent (a) and the SP value δb of the organic solvent (b) is 2.5 or less (preferably 2.0 or less, and more preferably 1.8 or less).
[Supplementary Note 41] The conductive paste for bonding according to any one of Supplementary Notes 1 to 40, wherein a difference [δa−δc] between the SP value δa of the organic solvent (a) and the SP value δc of the organic solvent (c) is 1.5 or more (preferably 2.0 or more).
[Supplementary Note 42] The conductive paste for bonding according to Supplementary Note 41, wherein the difference [δa−δc] between the SP value δa of the organic solvent (a) and the SP value δc of the organic solvent (c) is 5.0 or less (preferably 4.0 or less, and more preferably 3.0 or less).
[Supplementary Note 43] The conductive paste for bonding according to any one of Supplementary Notes 1 to 42, wherein a proportion [organic solvent (a)/{organic solvent (a)+organic solvent (b)+organic solvent (c)}] of the organic solvent (a) to a total amount of 100 mass % of the organic solvent (a), the organic solvent (b), and the organic solvent (c) is from 5 to 70 mass % (preferably from 10 to 60 mass %, and more preferably from 15 to 50 mass %).
[Supplementary Note 44] The conductive paste for bonding according to any one of Supplementary Notes 1 to 43, wherein a proportion [organic solvent (b)/{organic solvent (a)+organic solvent (b)+organic solvent (c)}] of the organic solvent (b) to the total amount of 100 mass % of the organic solvent (a), the organic solvent (b), and the organic solvent (c) is from 5 to 70 mass % (preferably from 10 to 60 mass %, and more preferably from 15 to 50 mass %).
[Supplementary Note 45] The conductive paste for bonding according to any one of Supplementary Notes 1 to 44, wherein a proportion [organic solvent (c)/{organic solvent (a)+organic solvent (b)+organic solvent (c)}] of the organic solvent (c) to a total amount of 100 mass % of the organic solvent (a), the organic solvent (b), and the organic solvent (c) is from 5 to 70 mass % (preferably from 10 to 60 mass %, and more preferably from 15 to 50 mass %).
[Supplementary note 46] The conductive paste for bonding according to any one of Supplementary Notes 1 to 45, wherein a content of the organic solvent (c) is from 20 to 400 parts by mass (preferably from 30 to 300 parts by mass, and more preferably from 50 to 200 parts by mass) relative to 100 parts by mass of the organic solvent (a).
[Supplementary note 47] The conductive paste for bonding according to any one of Supplementary Notes 1 to 46, wherein a content of the organic solvent (b) is from 10 to 200 parts by mass (preferably from 20 to 150 parts by mass, and more preferably from 40 to 100 parts by mass) relative to a total amount of 100 parts by mass of the organic solvent (a) and the organic solvent (c).
[Supplementary Note 48] The conductive paste for bonding according to any one of Supplementary Notes 1 to 47, wherein a total content proportion of the organic solvent (a), the organic solvent (b), and the organic solvent (c) in the dispersion medium is 50 mass % or more (preferably 70 mass % or more, more preferably 80 mass % or more, even more preferably 90 mass % or more, and particularly preferably 95 mass % or more) relative to a total amount of 100 mass % of the dispersion medium.
[Supplementary Note 49] The conductive paste for bonding according to any one of Supplementary Notes 1 to 48, wherein a content proportion of the metal particles in the conductive paste for bonding is from 70 to 99.5 mass % (preferably 80 to 98 mass %, and more preferably 85 to 95 mass %) relative to a total amount of 100 mass % of the conductive pastes for bonding.
[Supplementary Note 50] The conductive paste for bonding according to any one of Supplementary Notes 1 to 49, wherein a content proportion of the dispersion medium in the conductive paste for bonding is from 0.5 to 30 mass % (preferably 2 to 20 mass %, and more preferably 5 to 15 mass %) relative to the total amount of 100 mass % of the conductive pastes for bonding.
[Supplementary Note 51] The conductive paste for bonding according to any one of Supplementary Notes 1 to 50, wherein a total content proportion of the metal particles and the dispersion medium in the conductive paste for bonding is 70 mass % or more (preferably 80 mass % or more, more preferably 90 mass % or more, and even more preferably 95 mass % or more) relative to the total amount of 100 mass % of the conductive pastes for bonding.
[Supplementary Note 52] The conductive paste for bonding according to any one of Supplementary Notes 1 to 51, wherein a bonding strength (in accordance with JIS Z3198) when a silver-plated copper substrate and a silver-plated Si chip are bonded via a sintered body of the conductive paste for bonding is 10 MPa or more (preferably 25 MPa or more, more preferably 30 MPa or more, and even more preferably 40 MPa or more)
[Supplementary Note 53] The conductive paste for bonding according to any one of Supplementary Notes 1 to 52, wherein a void ratio of the sintered body of the conductive pastes for bonding, as measured using a scanning acoustic tomograph, is 15% or less (preferably less than 8%).

1. A conductive paste for bonding comprising: metal nanoparticles (A) having an average particle size of 1 nm or more and less than 100 nm, and a dispersion medium containing an organic solvent (a), an organic solvent (b), and an organic solvent (c),
wherein
the metal nanoparticles (A) are coated on surfaces thereof with an organic protective agent containing an amine and dispersed in the dispersion medium, and
the organic solvent (a), the organic solvent (b), and the organic solvent (c) are different compounds and satisfy the following formulas (1) to (6):
$$150 ° C . \leq Ta \leq 250 ° C . \qquad ( 1 )$$
$$150 ° C . \leq Tb \leq 250 ° C . \qquad ( 2 )$$
$$250 ° C . \leq Tc \leq 350 ° C . \qquad ( 3 )$$
$$δ a \geq 10. \qquad ( 4 )$$
$$δ c \leq 9. \qquad ( 5 )$$
$$δ c \leq δ b \leq δ a \qquad ( 6 )$$
wherein Ta to Tc represent boiling points of the organic solvents (a) to (c), respectively, and δa to δc represent Hansen solubility parameters of the organic solvents (a) to (c), respectively.

2. The conductive paste for bonding according to claim 1, further comprising spherical metal particles (B) having an average particle size of from 0.5 to 1 μm and flat metal flakes (C) having an average particle size of from 1 to 10 μm.

3. The conductive paste for bonding according to claim 2, wherein a total content proportion of the metal nanoparticles (A), the spherical metal particles (B), and the flat metal flakes (C) in the conductive paste for bonding is from 80 to 99.5 mass %.

4. The conductive paste for bonding according to claim 1,
wherein a content proportion of the metal nanoparticles (A) in all metal particles contained in the conductive paste for bonding is 50 mass % or less.

5. The conductive paste for bonding according to claim 1,
wherein the organic protective agent contains, as the amine, an aliphatic hydrocarbon monoamine (1) including an aliphatic hydrocarbon group and one amino group, the aliphatic hydrocarbon group having 6 or more carbon atoms in total, and the organic protective agent further contains at least one of an aliphatic hydrocarbon monoamine (2) or an aliphatic hydrocarbon diamine (3), the aliphatic hydrocarbon monoamine (2) including an aliphatic hydrocarbon group and one amino group, the aliphatic hydrocarbon group having 5 or less carbon atoms in total, and the aliphatic hydrocarbon diamine (3) including an aliphatic hydrocarbon group and two amino groups, the aliphatic hydrocarbon group having 8 or less carbon atoms in total.

6. The conductive paste for bonding according to claim 1, further comprising an organic solvent besides the organic solvent (a), the organic solvent (b), and the organic solvent (c).

7. The conductive paste for bonding according to claim 1, wherein the organic solvent (a), the organic solvent (b), and the organic solvent (c) are uniformly dissolved at an ordinary temperature without phase separation.
